(19) United States
(12) Patent Application Publication
(10) Pub. No.: US 2016/0006988 A1
(43) Pub. Date: Jan. 7, 2016

(54) SURVEILLANCE APPARATUS AND ASSOCIATED SURVEILLANCE METHOD

(71) Applicant: Sercomm Corporation, Taipei (TW)

(72) Inventors: Shao-Hai Zhao, Jiangsu Province (CN); Qian-Liang Luo, Jiangsu Province (CN)

(21) Appl. No.: 14/691,634

(22) Filed: Apr. 21, 2015

(30) Foreign Application Priority Data
Jul. 1, 2014 (CN) 201410310345.7

(51) Int. Cl. H04N 7/18

(52) U.S. Cl. CPC H04N 7/181

(57) ABSTRACT

A surveillance apparatus and an associated surveillance method are provided. The surveillance apparatus includes a video recorder, an infrared sensor and a motion detector. The surveillance method includes following steps. First, a video stream corresponding to a surveillance region is captured. Then, an infrared status of an infrared sensing region is sensed to selectively generate a trigger signal. The infrared sensing region and the surveillance region are partially overlapped. A motion detection signal according to the video stream is selectively generated. Whether a moving object is detected is determined according to the trigger signal and the motion detection signal.

This application claims the benefit of People's Republic of China Application Serial No. 201410310345.7, filed Jul. 1, 2014, the subject matter of which is incorporated herein by reference.

### BACKGROUND

1. Technical Field

The present disclosure relates in general to surveillance, and more particularly to a surveillance apparatus and an associated surveillance method for detecting a moving object.

2. Description of the Related Art

Surveillance systems are a critical part in modern public safety and security measures in the recent years. In addition to offering a real-time surveillance function, surveillance systems also provide a recording function. However, most parts in video streams (streaming video signals) generated by surveillance systems are insignificant surveillance videos that are without changes. Therefore, there is a need for a solution that is capable of accurately determining parts in a surveillance video stream worthy of user attention.

### SUMMARY

The present disclosure is directed to a surveillance apparatus and an associated surveillance method capable of enhancing determination accuracy as well as reducing misjudgment probabilities.

According to an embodiment of the present disclosure, a surveillance apparatus is provided. The surveillance apparatus includes a video recorder, an infrared sensor, and a motion detector. The video recorder captures a video stream corresponding to a surveillance region. The infrared sensor selectively generates a trigger signal in response to an infrared status of an infrared sensing region. The infrared sensing region is partially overlapped with the surveillance region. The motion detector selectively generates a motion detection signal according to the video stream. The surveillance apparatus determines whether a moving object is detected according to the trigger signal and the motion detection signal.

According to another embodiment of the present disclosure, a surveillance method applied to a surveillance apparatus is provided. The surveillance method includes steps of: capturing a video stream corresponding to a surveillance region; sensing an infrared status of an infrared sensing region to selectively generate a trigger signal, the infrared sensing region partially overlapping with the surveillance region; selectively generating a motion detection signal according to the video stream; and determining whether a moving object is detected according to the trigger signal and the motion detection signal.

The above and other aspects of the disclosure will become better understood with regard to the following detailed description of the non-limiting embodiments. The following description is made with reference to the accompanying drawings.

### BRIEF DESCRIPTION OF THE DRAWINGS

FIG. 1 is a block diagram of a surveillance apparatus of the present disclosure;

FIG. 2A and FIG. 2B are schematic diagrams showing a comparison of parts corresponding to a motion detection region in monitored images;

FIG. 3 is a section view of a surveillance region;

FIG. 4 is a schematic diagram of a viewing angle corresponding to the surveillance region;

FIG. 5 is a timing diagram that reflects changes in a surveillance region in an application of a surveillance method according to an embodiment of the present disclosure; and

FIGS. 6A and 6B are flowcharts of a surveillance method according to an embodiment of the present disclosure.

### DETAILED DESCRIPTION OF EMBODIMENTS

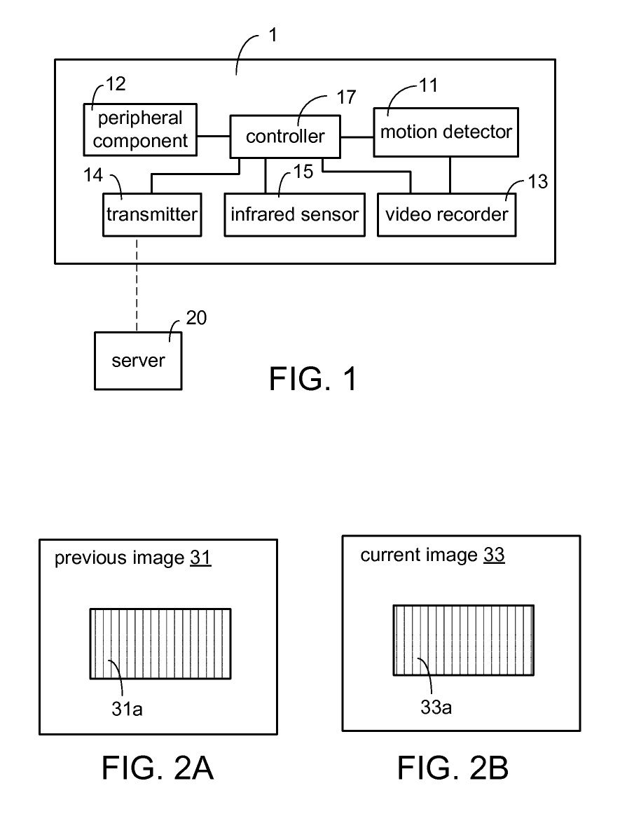

FIG. 1 shows a block diagram of a surveillance apparatus of the present disclosure. A surveillance apparatus 1 may be an IP camera and in communication with a server 20. The surveillance apparatus 1 includes a peripheral component 12, a transmitter 14, a controller 17, a motion detector 11, an infrared sensor 15 and a video recorder 13. The controller 17 is electrically connected to the peripheral component 12, the transmitter 14, the motion detector 11, the infrared sensor 15 and the video recorder 13.

For example, the infrared sensor 15 is a passive infrared (PIR) sensor, which passively senses an infrared band. When an object having a surface temperature that is different from the ambient temperature moves in an infrared sensing region of the PIR sensor, the PIR sensor generates a trigger signal. An independently used PIR sensor may incur a greater number of misjudgments, including false positives and false negatives.

The motion detector 11 is electrically connected to the video recorder 13. The video recorder 13 captures a video stream, which includes multiple successive images. The motion detector 11 compares contents of these successive images to determine whether a moving object is present.

FIG. 2A and FIG. 2B show schematic diagrams of a comparison of parts corresponding to a motion detection region in monitored images. From a previous image 31 and a current image 33, the motion detector 11 compares the motion detection regions 31a and 33a.

For example, the motion detector 11 may be a digital signal processor (DSP), and is capable of calculating a difference between the motion detection regions 31a and 33a from the previous image 31 and the current image 33. For example, a sum of absolute differences (SAD) of pixels may represent the level of change between the two monitored images. When the level of change is greater than a predetermined level, the motion detector 11 starts or continues generating a motion detection signal. When the level of change is smaller than or equal to the predetermined level, the motion detector 11 stops generating or continues not generating the motion detection signal. However, the motion detector 11 may have misjudgments.

According to a concept of the present disclosure, a region corresponding to the infrared sensor 15 is defined as an infrared sensing region, and a region that can be sensed by the motion detector 11 is defined as a motion detection region (that is, image comparison region). Further, an overlapping region of the infrared sensing region and the motion detection region is defined as an alert region. It should be noted that, sizes of the infrared sensing region and the motion detection region are not limited.

The controller 17 receives the motion detection signal from the motion detector 11 and the trigger signal from the infrared sensor 15. Accordingly, the controller 17 determines whether the surveillance apparatus 1 detects a moving object (for example, an intruding thief).

The controller 17 of the present disclosure determines whether a moving object is present in a surveillance region according to a predetermined condition. When the predetermined condition is satisfied, it means that a moving object is present in the surveillance region, and the controller 17 generates an alert signal. Upon receiving the alert signal, the peripheral component 12, the transmitter 14 or the video recorder 13 then correspondingly performs a process routine. According to a concept of the present disclosure, the process routine may be performed by the peripheral component 12, the transmitter 14 and/or the video recorder 13.

For example, the peripheral component 12 may be a siren or a lighting device. Upon receiving the alert signal, the peripheral component 12 sends out a loud sound or emits light as the process routine to deter intruders. For another example, in the process routine, the transmitter 14 may transmit the video stream captured by the video recorder 13 to the server 20. As such, a surveillance staff at a remote end is allowed to accurately stay fully aware of activities in the surveillance region.

For example, the video recorder 13 may dynamically adjust the recording quality of the video stream according to whether the alert signal is received. As previously stated, the surveillance apparatus 1 may implement the process routine by a versatile approach using the peripheral component 12, the transmitter 14 and/or the video recorder 13.

For example, when the alert signal is generated, the video recorder 13 captures the video stream at a first recording quality; and when the alert signal is not generated, the video recorder 13 captures the video stream at a second recording quality. The first recording quality is better than the second recording quality. A difference between the first recording quality and the second recording quality may refer to a compression rate and/or a frame rate of the video stream.

Take the frame rate for example, when the first recording quality is adopted, the video recorder 13 captures a greater number of images per second. When the second recording quality is adopted, the video recorder 13 captures a fewer number of images per second. For the sake of simplicity, in the embodiment below, the first recording quality is a predetermined recording quality and the second recording quality is an energy-saving recording quality.

In the present disclosure, a predetermined condition may be defined according to the trigger signal and the motion detection signal. In response to the established predetermined condition, the controller 17 generates an alert signal to the video recorder 13. In other words, the controller 17 determines whether the predetermined condition is established or not according to the trigger signal and the motion detection signal. The surveillance apparatus 1 of the present disclosure integrates sensing functions of a PIR sensor and a motion detector 11 to provide a double-verification effect, thereby reducing misjudgments.

In addition to the above elements, the surveillance device 1 further includes elements such as a lens and a network storage module, which are not discussed in detail herein. The surveillance apparatus 1 may store the captured video stream, or transmit the captured video stream to the server 20 at the remote end via a network.

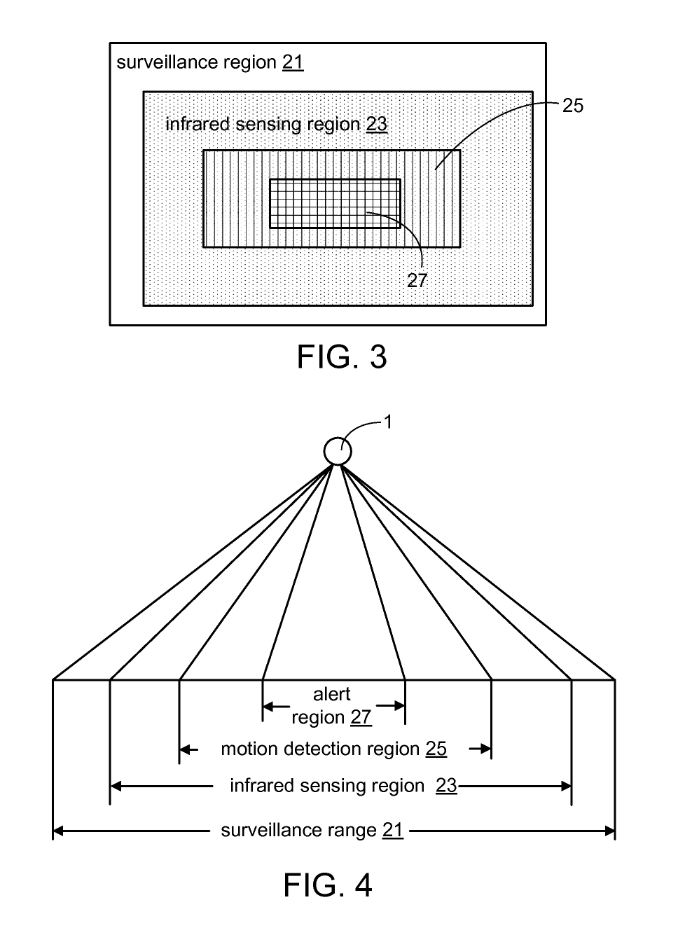

FIG. 3 shows a section view of a surveillance region of the present disclosure. The infrared sensing region 23 is slightly smaller than the surveillance region 21. In the example, the overlapping region of the infrared sensing region 23 and the motion detection region 25 includes the alert region 27, which concerns the user most. With the collaboration of the infrared sensor 15 and the motion detector 11, misjudgments can be reduced.

FIG. 4 shows a schematic diagram of a viewing angle corresponding to the surveillance region 21. The viewing angle in FIG. 4 corresponds to the section view in FIG. 3. In this example, the viewing angle corresponding to the alert region 27, the viewing angle corresponding to the motion region 25, the viewing angle corresponding to the infrared sensing region 23, and the viewing angle corresponding to the surveillance region 21 are in turn the smallest to the largest.

As previously stated, the controller 17 determines whether the predetermined condition is established according to the trigger signal and the motion detection signal. For illustration purposes, in the description below, it is assumed that the predetermined condition is determined according to a time difference between a start time point of the motion detection signal T_img and a start time point of the trigger signal T_pir. Further, the predetermined condition is to compare the calculated time difference with a predetermined threshold Tth. When the time difference is smaller than or equal to the predetermined threshold Tth, the controller 17 deems that the predetermined condition is satisfied, and generates the alert signal. Otherwise, the controller 17 deems that the predetermined condition is not satisfied, and does not generate the alert signal.

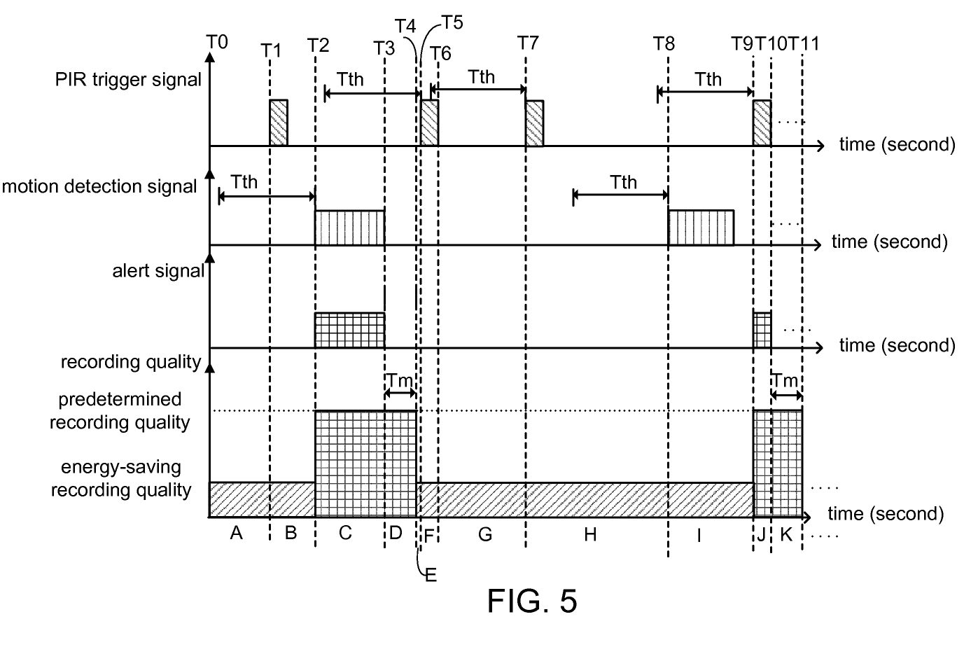

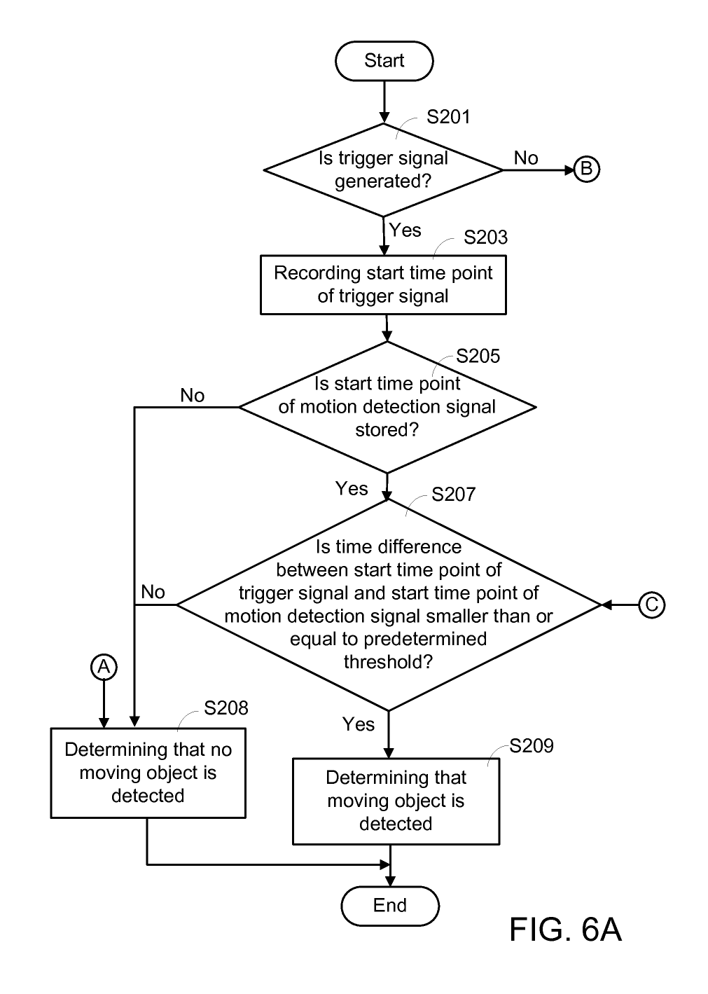

FIG. 5 shows a timing diagram that reflects changes in a surveillance region in an application of a surveillance method according to an embodiment of the present disclosure. In the timing diagram, the PIR trigger signal, the motion detection signal, the alert signal, and the recording quality are respectively depicted from top to bottom.

When the surveillance apparatus 1 is turned on at time point T0, no PIR trigger signal nor motion detection signal is generated. Thus, the controller 17 does not generate the alert signal. From the time point T0 to time point T1 (period A), the video recorder 13 captures the video stream at the energy-saving recording quality.

At time point T1, the infrared sensor 15 starts to generate the 1^{st} PIR trigger signal, and the controller 17 records time point T1 as the start time point of the PIR trigger signal (that is, T_pir=T1). At this point, the motion detector 11 has not yet generated any motion detection signal, so the controller 17 determines that no moving object is detected at time point T1. Thus, the video recorder 13 keeps capturing the video stream at the energy-saving recording quality in period B.

At time point T2, the motion detector 11 starts to generate the 1^{st} motion detection signal. At this point, the controller 17 records the time point T2 as the start time point of the motion detection signal (that is, T_img=T2). The controller 17 further calculates a time difference (|T_img−T_pir|=|T2−T1|) between the stored start time point of the motion detection signal (that is, T_img=T2) and the stored start time point of the 1^{st} PIR trigger signal (that is, T_pir=T1).

The controller 17 compares the calculated time difference (|T_img−T_pir|=|T2−T1|) with a predetermined threshold Tth, and determines that the time difference is smaller than the predetermined threshold (|T_img−T_pir|<Tth). In FIG. 5, applying the determination equation between the time difference and the predetermined threshold Tth implies to determine whether a result of subtracting time point T2 by the predetermined threshold Tth is earlier than time point T1. If so, the predetermined condition is established at time point T2.

Accordingly, the controller 17 determines that the predetermined condition is established at time point T2, which means that the surveillance apparatus 1 has detected a moving object. In practice, the length of the predetermined threshold Tth (for example, 1 second) may be user-selected or may be a default value stored in the surveillance apparatus 1.

Thus, from time point T2, the controller 17 starts to generate and transmit the alert signal to the video recorder 13. Upon receiving the alert signal, from time point T2, the video recorder 13 starts to capture the video stream at the predetermined recording quality. The motion detector 11 generates the 1^{st} motion detection signal in period C between time point T2 and time point T3. In period C, the controller 17 continues generating the alert signal to the video recorder 13, and the video recorder 13 keeps capturing the video stream at the predetermined recording quality.

In FIG. 5, the 1^{st} motion detection signal stops at time point T3, and the controller 17 also immediately stops generating the alert signal at time point T3. Considering the integrity of recording effects, the video recorder 13 may keep capturing for a short continued capturing period Tm after the alert signal ends. As shown in FIG. 5, although the controller 17 has stopped generating the alert signal at time point T3, the video recorder 13 still captures the video stream at the predetermined recording quality in period D from time point T3 to time point T4. At time point T4, the continued capturing period Tm ends, and the video recorder 13 at this point then changes to capture the video stream at the energy-saving recording quality. In period E, the video recorder 13 keeps capturing the video stream at the energy-saving recording quality.

At time point T5, the infrared sensor 15 starts to generate the 2^{nd} PIR trigger signal, and the controller 17 records the start time point of the 2^{nd} PIR trigger signal (that is, T_pir=T5). Next, the controller 17 determines whether a result of subtracting time point T5 by the predetermined threshold Tth is earlier than the start time point of the stored motion detection signal (that is, T_img=T2).

As seen from FIG. 5, the time difference between the start time point of the 2^{nd} PIR trigger signal (time point T5) and the start time point of the 1^{st} motion detection signal (time point T2) is greater than the predetermined threshold (|T_img−T_pir|=|T2−T5|>Tth). Accordingly, the controller 17 determines that the 2^{nd} PIR trigger signal may be generated due to a mistake of the infrared sensor 15, so the controller 17 determines that the predetermined condition is not established. Further, the controller 17 does not generate the alert signal at time point T5. After time point T5, the video recorder 13 keeps capturing the video stream at the energy-saving recording quality until the 2^{nd} PIR trigger signal ends at time point T6.

As seen from FIG. 5, in period G, from the 2^{nd} PIR trigger signal ends at time point T6 till time point T7 at which the controller 17 starts to generate the 3^{rd} PIR trigger signal, the controller 17 does not generate any alert signal. Thus, the video recorder 13 keeps capturing the video stream at the energy-saving recording quality in period G.

At time point T7, the infrared sensor 15 starts to generate the 3^{rd} PIR trigger signal. At this point, the controller 17 records the start time point of the 3^{rd} PIR trigger signal (that is, time point T7). As the time difference (|T_pir−T_img|=|T7−T2|) between the start time point of the 3^{rd} PIR trigger signal (T_pir=T7) and the start time point of the existing first motion detection signal stored (T_img=T2) is greater than the predetermined threshold Tth, the controller 17 determines that the predetermined condition is not established at time point T7. As a result, after time point T7, the controller 17 still does not generate the alert signal to the video recorder 13, and the video recorder 13 keeps capturing the video stream at the energy-saving recording quality.

In a period H between time point T7 and time point T8, the video recorder 13 captures the video stream at the energy-saving recording quality. At time point T8, the motion detector 11 starts to generate the second motion detection signal, and the controller 17 records the start time point of the 2^{nd} motion detection signal (T_img=T8). Next, the controller 17 calculates the time difference between the start time point of the 2^{nd} motion detection signal (T_img=T8) and the start time point of the existing PIR trigger signal stored (T_pir=T7). Because the time difference is greater than the predetermined threshold (|T_img−T_pir|=|T8−T7|>Tth), the controller 17 determines that the predetermined condition is not established. Thus, after time point T8, the controller 17 still refrains from generating the alert signal. In period I between time point T8 and time point T9, the video recorder 13 keeps capturing the video stream at the energy-saving recording quality.

At time point T9, the infrared sensor 15 starts to generate the 4^{th} PIR trigger signal, and the controller 17 records the start time point of the 4^{th} PIR trigger signal (T_pir=T9). Next, the controller 17 calculates the time difference (|T_img−T_pir|=|T9−T8|) between the start time point of the 4^{th} PIR trigger signal (T_pir=T9) and the start time point of the existing motion detection signal stored (T_img=8). The controller 17 determines that the calculated time difference is smaller than the predetermined threshold (|T_img−T_pir|=|T9−T8|<Tth), which means that the predetermined condition is established at time point T9. Thus, from time point T9, the controller 17 starts to generate the alert signal. Upon receiving the alert signal, the video recorder 13 changes to capture the video stream at the predetermined recording quality. In period J from time point T9 to time point T10, the controller 17 generates the alert signal, and the video recorder 13 captures the video stream at the predetermined recording quality.

The 4^{th} PIR trigger signal ends at time point T10, and the controller 17 correspondingly stops generating the alert signal at time point T10 because both the PIR trigger signal and the motion detection signal are stopped being generated. The video recorder 13 may keep capturing for a short continued capturing period Tm after the alert signal ends at time point T10. For example, only after the continued capturing period Tm from time point T10 to time point T11, the video recorder 13 restores to capture the video stream at the energy-saving recording quality.

As previously described, the predetermined condition is determined according to the motion detection signal and the PIR trigger signal. In practice, the approach for defining the predetermined condition may vary according to the start time points and/or end time points of the motion detection signal and the PIR trigger signal. In response to whether the predetermined condition is established, the controller 17 selectively generates the alert signal.

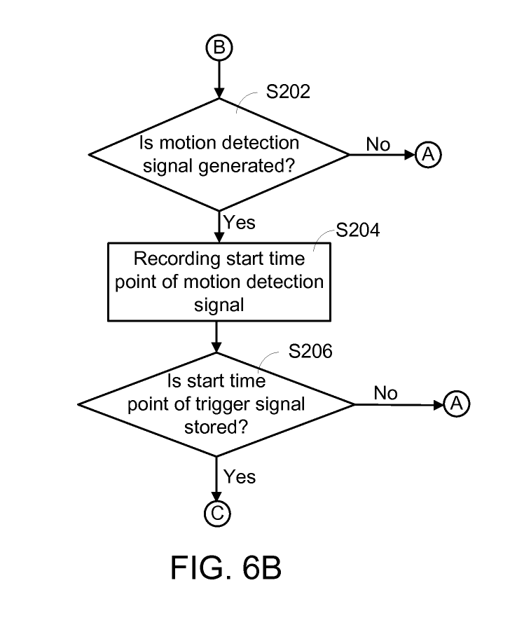

FIGS. 6A and 6B show flowcharts according to an embodiment of the present disclosure. It is assumed that the predetermined condition is whether the time difference between the start time point of the trigger signal and the start time of the motion detection signal is smaller than or equal to the predetermined threshold Tth. In step S201, the controller 17 first determines whether the infrared sensor 15 generates a trigger signal. When a determination result of step S201 is affirmative, step S203 is performed to record a start time point of the trigger signal. In step S205, the controller 17 determines whether a start time point of a motion detection signal is stored. If the answer is negative, the controller 17 determines that the surveillance apparatus 1 has not detected a moving object in step S208.

When a determination result of step S205 is affirmative, step S207 is performed. In step S207, the controller 17 further calculates a time difference between the start time point of the trigger signal and the start time point of the motion detection signal and determines whether the calculated time difference is smaller than or equal to the predetermined threshold Tth.

When a determination result of step S207 is affirmative, the controller 17 determines that the surveillance apparatus 1 has detected a moving object in step S209. The controller 17 may then generate the alert signal. After the peripheral component 12, the transmitter 14 and/or the video recorder 13 of the surveillance apparatus 1 receive the alert signal, the surveillance apparatus 1 correspondingly performs the process routines.

When the determination result of step S207 indicates that the calculated time difference is greater than the predetermined threshold Tth, the controller 17 determines that the surveillance apparatus 1 has detected no moving object in step S208. On the other hand, when the determination result of step S201 is negative, in step S202, the controller 17 determines whether the motion detector 11 generates a motion detection signal. When the motion detector 11 does not send out any motion detection signal, in step S208, the surveillance apparatus 1 determines that no moving object has been detected. When the motion detector 11 sends out a motion detection signal, the start time point of the motion detection signal is recorded in step S204.

In step S206, the controller 17 determines whether the start time point of the trigger signal is stored in the surveillance apparatus 1. If not, the controller 17 determines that there is no moving object in step S208. When the start time point of the trigger signal is stored in the surveillance apparatus 1, step S207 is performed. In step S207, the controller 17 further calculates a time difference between the start time point of the trigger signal and the start time point of the motion detection signal, and determines whether the calculated time difference is smaller than or equal to the predetermined threshold Tth.

Based on a concept of the present disclosure, the predetermined condition is defined according to the trigger signal and the motion detection signal. Further, according to whether the predetermined condition is established, the controller 17 determines whether the surveillance apparatus 1 detects a moving object. Thus, the surveillance apparatus 1 may accordingly determine whether to issue an alert message and/or change the recording quality of the video recorder 13. The controller 17 may adopt different approaches for controlling the subsequent process routines in response to the presence of a moving object.

In conclusion, the surveillance apparatus 1 of the present disclosure integrates functions of the motion detector 11 and the infrared sensor 15. When only one of the motion detector 11 and the infrared sensor 15 detects an abnormality, the surveillance apparatus 1 determines that the surveillance apparatus 1 has detected no moving object. When the abnormal activity in the surveillance region 21 causes the motion detector 11 to send out a motion detection signal and the infrared sensor 15 to send out a trigger signal, the surveillance apparatus then determines that a moving object has been detected. As such, the determination accuracy is enhanced and misjudgments are reduced.

While the disclosure has been described by way of example and in terms of the embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A surveillance apparatus, comprising:
a video recorder, for capturing a video stream corresponding to a surveillance region;
an infrared sensor, for selectively generating a trigger signal in response to a status of an infrared sensing region, wherein the infrared sensing region is partially overlapped with the surveillance region; and
a motion detector, for selectively generating a motion detection signal according to the video stream,
wherein the surveillance apparatus determines whether a moving object is detected according to the trigger signal and the motion detection signal.

2. The surveillance apparatus of claim 1, wherein the infrared sensor is a passive infrared (PIR) sensor.

3. The surveillance apparatus of claim 1, further comprising:
a controller, electrically connected to the infrared sensor and the motion detector, for generating an alert signal when the trigger signal and the motion detection signal satisfy a predetermined condition.

4. The surveillance apparatus of claim 3, wherein the video recorder dynamically adjusts recording quality of the video stream according to generation of the alert signal.

5. A surveillance method, comprising steps of:
capturing a video stream corresponding to a surveillance region;
sensing a status of an infrared sensing region to selectively generate a trigger signal, wherein the infrared sensing region is partially overlapped with the surveillance region;
selectively generating a motion detection signal according to the video stream; and
determining whether a moving object is detected according to the trigger signal and the motion detection signal.

6. The surveillance method of claim 5, wherein the step of determining whether the moving object is detected according to the trigger signal and the motion detection signal comprises steps of:
determining whether the trigger signal and the motion detection signal satisfy a predetermined condition; and
dynamically adjusting recording quality of the video stream according to whether the predetermined condition is satisfied.
